(19) United States
(12) Patent Application Publication
(10) Pub. No.: US 2020/0013522 A1
(43) Pub. Date: Jan. 9, 2020

(54) COPPER-CONTAINING THICK PRINT ELETROCONDUCTIVE PASTES

(71) Applicant: Heraeus Precious Metals North America Conshohocken LLC, West Conshohocken, PA (US)

(72) Inventors: Virginia C. Garcia, Carteret, NJ (US); Ryan Persons, Newton Square, PA (US); Gregory Berube, Nashua, NH (US); Matthew Sgriccia, Douglassville, PA (US)

(21) Appl. No.: 16/494,732

(22) PCT Filed: Jun. 7, 2018
(86) PCT No.: PCT/US18/36499

§ 371 Date: Sep. 16, 2019

Related U.S. Application Data
(60) Provisional application No. 62/526,623, filed on Jun. 29, 2017.

(51) Int. Cl. H01B 1/22; C03C 8/18

(52) U.S. Cl. CPC H01B 1/22; C03C 8/18

(57) ABSTRACT

The invention provides an electroconductive paste for use in forming an electrode on a silicon nitride substrate which includes at least two types of copper particles each having a different median particle diameter (d₅₀), a glass frit comprising at least bismuth oxide, silicon oxide, and boron oxide, at least one adhesion promoting additive comprising aluminum oxide, cerium oxide, or combinations thereof, and an organic vehicle. The invention is also directed to an electroconductive paste for use in forming an electrode on an aluminum nitride substrate, which includes at least three types of copper particles each having a different median particle diameter (d₅₀), a glass frit comprising at least bismuth oxide and silicon oxide, and boron oxide, at least one adhesion promoting additive comprising bismuth oxide, zinc oxide, titanium oxide, cerium oxide, or combinations thereof, and an organic vehicle.

### TECHNICAL FIELD

The invention relates to thick print electroconductive paste compositions suitable for printing on silicon nitride and aluminum nitride substrates. The electroconductive paste compositions disclosed herein may be used in high temperature, high voltage and/or high amperage electronics applications (e.g., in electric vehicles).

### BACKGROUND

In recent years, it has become desirable to employ silicon nitride (Si₃N₄) and aluminum nitride (AlN) substrates for circuit boards used in high temperature environments, particularly for high power applications. Such substrates have been promising candidates due to their excellent properties, including high thermal conductivity (80-230 Wm⁻¹K⁻¹) and low coefficient of thermal expansion (CTE) (2.5-4.5 ppmK⁻¹). The combination of high thermal conductivity and low CTE makes silicon nitride and aluminum nitride better options for use in these types of applications, because of their increased reliability during thermal cycling, owing in part to the fact that their CTE is closer to that of silicon. Furthermore, silicon nitride and aluminum nitride have equal or better flexural strength than that of alumina or beryllium oxide (commonly used in these types of applications), which in turn provides better resistance to conchoidal cracking, which is the root cause for most failures with alumina constructions.

Despite the promise of AlN and Si₃N₄ substrates, application of thick films on these substrates is limited by the lack of compatible thick film paste compositions which adhere sufficiently to such materials. In order to adhere metal conductors to these substrates, the use of thick film technology is typically used, which adheres the conductor via a thin reactive layer (oxide film) formed between the metal and substrate by introducing the metal in atomic form to the surface of the ceramic substrate so that the metal, which is extremely active chemically, bonds with the excess oxygen that exists in the surface of the substrate. Substrates formed by this method are commonly referred to as direct bonded copper (DBC) substrates. However, DBC substrates have difficulty withstanding the thermal cycling that occurs throughout their lifetime, thus reducing their mechanical reliability. Accordingly, electroconductive pastes which are suitable for printing onto AlN and Si₃N₄ substrates to form thick film conductor layers, and which exhibit improved stability and adhesion thereto, are desired.

Moreover, while AlN substrates have good thermal and mechanical properties for use in high temperature circuit applications, there is an increasing desire to move toward Si₃N₄ substrates because they have even better mechanical properties as compared to AlN substrates. However, electroconductive pastes that are formulated for use with AlN substrates are often not suitable for use with Si₃N₄ substrates due to a lack of adhesion. There is, therefore, a need for thick print electroconductive pastes that are particularly suitable for use with Si₃N₄ substrates and exhibit improved stability and adhesion thereto.

### SUMMARY

Accordingly, the invention provides an electroconductive paste compositions which exhibit excellent adhesion properties when applied to silicon nitride and/or aluminum nitride substrates.

The invention provides an electroconductive paste for use in forming an electrode on a silicon nitride substrate. The electroconductive paste includes about 50-95 wt % of a conductive metallic component comprising at least two types of copper particles each having a different median particle diameter (d₅₀), about 0.5-10 wt % of a glass frit comprising at least bismuth oxide, silicon oxide, and boron oxide, about 0.1-5 wt % of at least one adhesion promoting additive comprising aluminum oxide, cerium oxide, or a combination thereof, and about 5-20 wt % of an organic vehicle. The wt % of each component is based upon 100% total weight of the electroconductive paste composition.

The invention further provides an electroconductive paste for use in forming an electrode on an aluminum nitride substrate. The electroconductive paste comprises about 50-95 wt % of a conductive metallic component comprising at least three types of copper particles each having a different median particle diameter (d₅₀), about 0.5-10 wt % of a glass frit comprising at least bismuth oxide and silicon oxide, and boron oxide, about 0.1-5 wt % of at least one adhesion promoting additive comprising bismuth oxide, zinc oxide, or a combination thereof, and about 5-20 wt % of an organic vehicle. The wt % of each component is based upon 100% total weight of the electroconductive paste composition.

The invention is also directed to an electronic device which includes a silicon nitride substrate and at least one electrode on the silicon nitride substrate, the electrode formed from an electroconductive paste which includes about 50-95 wt % of a conductive metallic component comprising at least two types of copper particles each having a different median particle diameter (d₅₀), about 0.5-10 wt % of a glass frit comprising at least bismuth oxide, silicon oxide, and boron oxide, about 0.1-5 wt % of at least one adhesion promoting additive comprising aluminum oxide, cerium oxide, or a combination thereof, and about 5-20 wt % of an organic vehicle. The wt % of each component is based upon 100% total weight of the electroconductive paste composition.

Lastly, the invention provides an electronic device which includes an aluminum nitride substrate and at least one electrode on the aluminum nitride substrate, the electrode formed from an electroconductive paste which includes about 50-95 wt % of a conductive metallic component comprising at least three types of copper particles each having a different median particle diameter (d₅₀), about 0.5-10 wt % of a glass frit comprising at least bismuth oxide and silicon oxide, and boron oxide, about 0.1-5 wt % of at least one adhesion promoting additive comprising bismuth oxide, zinc oxide, or a combination thereof, and about 5-20 wt % of an organic vehicle. The wt % of each component is based upon 100% total weight of the electroconductive paste composition.

The invention is also directed to an electroconductive paste for use in forming an electrode on a silicon nitride substrate. The paste includes about 50-95 wt % of a conductive metallic component comprising at least two types of copper particles each having a different median particle diameter (d₅₀), at least about 5 wt % of a glass frit comprising at least bismuth oxide, silicon oxide, and boron oxide, and about 5-20 wt % of an organic vehicle, wherein wt % is based upon 100% total weight of the electroconductive paste composition.

### BRIEF DESCRIPTION OF DRAWINGS

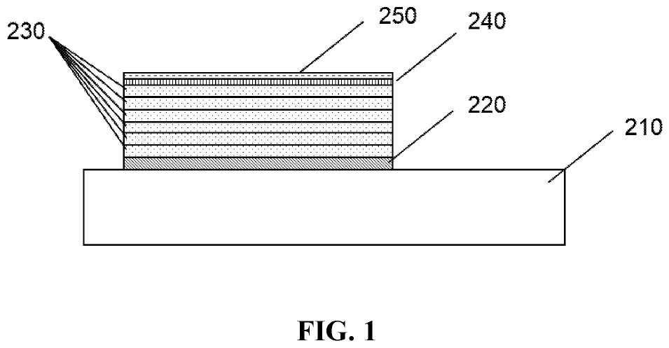

A more complete appreciation of the invention and many of the attendant advantages thereof will be readily obtained as the same becomes better understood by reference to the following detailed description when considered in connection with the accompanying drawing, FIG. 1, which is a cross-view of multiple layers of an exemplary electroconductive paste printed and fired on a substrate.

### DETAILED DESCRIPTION

The invention relates to an electroconductive paste composition suitable for forming thick film layers on a silicon nitride (Si₃N₄) substrate or aluminum nitride (AlN) substrate. In particular, the invention relates to electroconductive paste compositions (hereinafter, “paste” or “pastes”) that may be printed onto these substrates to form conductor layers on circuit boards used under high temperature environments, particularly for high power applications, such as in electric vehicles. The pastes set forth herein, whether formulated for use with Si₃N₄ substrates or AlN substrates, exhibit excellent stability and adhesion to the underlying substrate.

The pastes according to the invention generally include a conductive component, a glass component, an organic vehicle component, and optional additive(s).

### Conductive Component

The conductive component of the paste generally includes conductive metallic particles. Preferred conductive metallic particles are those which exhibit optimal conductivity and which effectively sinter upon firing, such that they yield electrodes with high conductivity. Conductive metallic particles known in the art suitable for use in forming electrodes are preferred, including, but not limited to, elemental metals, alloys, mixtures of at least two metals, mixtures of at least two alloys or mixtures of at least one metal with at least one alloy. Metals which may be employed as the metallic particles include at least one of silver, copper, gold, aluminum, nickel, platinum, palladium, molybdenum, and mixtures or alloys thereof. In a preferred embodiment, the metallic particles are copper. The copper particles may be present as elemental copper, one or more copper derivatives, or mixtures thereof. Copper powders may vary based on the production method, purity, particle size, particle shape, apparent density, conductivity, oxygen level, color and flow rate.

The copper particles can exhibit a variety of shapes, surfaces, sizes, surface area to volume ratios, oxygen content and oxide layers. Some examples of shapes include, but are not limited to, spherical, angular, elongated (rod or needle like) and flat (sheet like). Copper particles may also be present as a combination of particles of different shapes. Copper particles with a shape, or combination of shapes, which favors advantageous sintering, electrical contact, adhesion and electrical conductivity of the produced electrode are preferred. In one embodiment, a combination of copper particles having a spherical shape and copper particles having an angular shape are used.

One way to characterize such shapes without considering their surface nature is through the following parameters: length, width, and thickness. In the context of the invention, the length of a particle is given by the length of the longest spatial displacement vector, both endpoints of which are contained within the particle. The width of a particle is given by the length of the longest spatial displacement vector perpendicular to the length vector defined above, both endpoints of which are contained within the particle.

The copper particles are typically irregular, however, the particle size may be approximately represented as the diameter of the “equivalent sphere” which would give the same measurement result. Typically, particles in any given sample of copper particles do not exist in a single size, but are distributed in a range of sizes, i.e., a particle size distribution. One parameter characterizing particle size distribution is d₅₀. d₅₀ is the median diameter or the medium value of the particle size distribution. It is the value of the particle diameter at 50% in the cumulative distribution. Other parameters of particle size distribution are D₁₀, which represents the particle diameter corresponding to 10% cumulative (from 0 to 100%) undersize particle size distribution, and D₉₀, which represents the particle diameter corresponding to 90% cumulative (from 0 to 100%) undersize particle size distribution. Particle size distribution may be measured via laser diffraction, dynamic light scattering, imaging, electrophoretic light scattering, or any other methods known to one skilled in the art. In a preferred embodiment, laser diffraction is used.

In one embodiment, the copper particles have substantially uniform shapes (i.e. shapes in which the ratios relating the length, the width and the thickness are close to 1, preferably all ratios lying in a range from about 0.7 to about 1.5, more preferably in a range from about 0.8 to about 1.3 and most preferably in a range from about 0.9 to about 1.2). For example, the copper particles of this embodiment may be spheres, cubes, or a combination thereof, or combinations of one or more thereof with other shapes. In another embodiment, the copper particles have a shape of low uniformity, preferably with at least one of the ratios relating the dimensions of length, width and thickness being above about 1.5, more preferably above about 3 and most preferably above about 5. Shapes according to this embodiment are flake shaped, rod or needle shaped, or a combination of flake shaped, rod or needle shaped with other shapes. In another embodiment, a combination of copper particles with uniform shape and less uniform shape may be used. Specifically, a combination of spherical copper particles and flake-shaped copper particles, having different particle sizes may be used.

In a preferred embodiment, a combination of copper particles of different particle sizes may be used. Without being bound by any particular theory, it is believed that a combination of copper particles having varying median particle diameters improves the adhesive performance of the paste composition.

For example, the pastes may include at least two types of copper particles, particularly where the paste is formulated for use with a Si₃N₄ substrate. A first type of copper particle may be a spherical copper particle having a median particle diameter (d₅₀) of at least about 2 μm, preferably at least about 3 μm, and more preferably at least about 4 μm. Preferably, the first type of copper particle has a d₅₀ of no more than about 7 μm, preferably no more than about 6 μm, and most preferably no more than about 5 μm. A second type of copper particle may be an angular copper particle having a d₅₀ of at least about 0.1 μm, preferably at least about 0.5 μm, and more preferably at least about 1 μm. Preferably, the second type of copper particle has a d₅₀ of no more than about 5 μm, preferably no more than about 4 μm, preferably no more than about 3 μm, and most preferably no more than about 2 μm.

In this embodiment, the paste preferably includes at least about 60 wt % of the first type of copper particle, preferably at least about 65 wt %, more preferably at least about 70 wt %, and most preferably at least about 75 wt %, based upon the total weight of the paste. The paste preferably includes no more than about 95 wt %, preferably no more than about 90 wt %, preferably no more than about 85 wt %, and most preferably no more than about 80 wt % of the first type of copper particle. The paste further includes at least about 0.5 wt % of the second type of copper particle, preferably at least about 1 wt %, more preferably at least about 2 wt %, and more preferably at least about 3 wt %, based upon the total weight of the paste. At the same time, the paste includes no more than about 20 wt %, preferably no more than about 15 wt %, more preferably no more than about 10 wt %, and most preferably no more than about 5 wt % of the second type of copper particle.

In another embodiment, particularly where the paste is formulated for use with an AlN substrate, the paste may comprise a combination of at least three types of copper particles. For example, the pastes may include a first spherical copper particle having a d₅₀ of about 3-4.5 μm, a second spherical copper particle having a d₅₀ of about 2.5-3.75 μm, and a third angular copper particle having a d₅₀ of about 4.5-6 μm. In this embodiment, the paste may include at least about 40 wt % of the first copper particle, preferably at least about 50 wt %, and no more than about 70 wt %, preferably no more than about 60 wt %, based upon 100% total weight of the paste. The paste further includes at least about 10 wt % of the second copper particle, preferably at least about 20 wt %, and no more than about 40 wt %, preferably no more than about 30 wt %, based upon 100% total weight of the paste. Lastly, the paste includes at least about 1 wt % of the third copper particle, preferably at least about 5 wt %, and no more than about 20 wt %, preferably no more than about 15 wt %, based upon 100% total weight of the paste.

In another embodiment, the copper particles may have a variety of surface types. Surface types which favor effective sintering and yield advantageous electrical contact and conductivity of the produced electrodes are favored according to the invention.

Another way to characterize the shape and surface of a copper particle is by its surface area to volume ratio, i.e., specific surface area. The lowest value for the surface area to volume ratio of a particle is embodied by a sphere with a smooth surface. The less uniform and uneven a shape is, the higher its surface area to volume ratio will be. In one embodiment, the copper particles have a high surface area to volume ratio, such as from about 1.0×10⁷ to about 1.0×10⁹ m⁻¹, from about 5.0×10⁷ to about 5.0×10⁸ m⁻¹ or from about 1.0×10⁸ to about 5.0×10⁸ m⁻¹. In another embodiment, the copper particles have a low surface area to volume ratio, such as from about 6×10⁵ to about 8.0×10⁶ m⁻¹, from about 1.0×10⁶ to about 6.0×10⁶ m⁻¹ or from about 2.0×10⁶ to about 4.0×10⁶ m⁻¹. The surface area to volume ratio, or specific surface area, may be measured by BET (Brunauer-Emmett-Teller) method, which is well known in the art.

The copper particles may be present with a surface coating. In an embodiment where multiple types of copper particles are used, having varying sizes, shapes, etc., one or more of the types of copper particles may be present with a surface coating. Any such coating known in the art, and which is considered to be suitable in the context of the present invention, may be employed on the copper particles. For example, the coating may be one or more of organic acids, organic amines, nitrogen-containing organic compounds, organic amides, organic alcohols, or any organic compound containing a heteroatom (N, O, S). In a preferred embodiment, the coating is formed of at least organic acid(s), organic amine(s), or a combination thereof. For example, the coating may be stearic or oleic acid.

In one embodiment, the coating promotes better particle dispersion, which can lead to improved printing and sintering characteristics of the electroconductive paste. In certain embodiments, the coating is present in less than about 10 wt %, such as less than about 8 wt %, less than about 5 wt %, less than about 4 wt %, less than about 3 wt %, less than about 2 wt %, less than about 1 wt %, or less than about 0.5 wt %, based on 100% total weight of the copper particles. In one embodiment, the coating is present in an amount of at least about 0.01 wt %, based upon 100% total weight of the copper particles.

In any of the above-described embodiments, the paste preferably comprises at least about 50 wt % of total copper particles, preferably at least about 55 wt %, more preferably at least about 60 wt %, more preferably at least about 65 wt %, more preferably at least about 70 wt %, more preferably at least about 75 wt %, and most preferably at least about 80 wt %, based upon 100% total weight of the paste. At the same time, the paste comprises no more than about 99 wt % of total copper particles, preferably no more than about 95 wt %, and more preferably no more than about 90 wt %, based upon 100% total weight of the paste.

### Glass Component

The paste includes a glass component that allows the conductive component to sufficiently adhere to the underlying substrate and make electrical contact therewith when fired. The glass component may also help to control the sintering of the conductive particles during firing, thereby improving electrical conductivity and adhesion to the substrate. In one embodiment, one or more glass frits may be used. The glass frit may be substantially amorphous, or may incorporate partially crystalline phases or compounds. The glass frit may include a variety of oxides or compounds known to one skilled in the art. For example, silicon, boron, bismuth, zinc, tellurium, manganese, copper, or chromium compounds (e.g., oxides) may be used. Other glass matrix formers or modifiers, such as germanium oxide, phosphorous oxide, vanadium oxide, tungsten oxide, molybdenum oxides, niobium oxide, tin oxide, indium oxide, other alkaline and alkaline earth metal oxides (such as Na, K, Li, Cs, Ca, Sr, Ba, and Mg), intermediates (such as Al, Ti, and Zr), and rare earth oxides (such as La₂O₃ and cerium oxides) may also be included in the glass frit.

In a preferred embodiment, the primary components of the glass frit include bismuth oxide (e.g., Bi₂O₃), silicon oxide (e.g., SiO₂), and boron oxide (e.g., B₂O₃). In another preferred embodiment, the glass frit further include zinc oxide (e.g., ZnO). Alternatively, any bismuth, silicon, and/or boron compound (e.g., H₃BO₃), that would produce the referenced oxides at firing temperature may be used. The glass frit may include other oxides, such as alkali oxides, in addition to the bismuth, silicon and boron oxides.

A glass frit comprising the following oxides, based upon 100% total weight of the glass frit, may be used to form a paste for application to a Si₃N₄ substrate: about 50-75% Bi₂O₃, about 10-25% SiO₂, about 1-10% ZnO, and about 10% or less of each of B₂O₃, Li₂O, Na₂O, and/or Nb₂O₅. In a preferred embodiment, the glass frit contains about 5 wt % or less of each of B₂O₃, Li₂O, Na₂O, and Nb₂O₅.

For an AlN substrate, a glass frit comprising the following oxides, based upon 100% total weight of the glass frit, may be used: about 40-60% Bi₂O₃, about 20-40% SiO₂, and about 10% or less of each of B₂O₃, Na₂O, Li₂O, Al₂O₃, TiO₂, and/or ZrO₂. In a preferred embodiment, the glass frit contains about 5-10 wt % of B₂O₃ and less than about 5 wt % of each of Na₂O, Li₂O, Al₂O₃, TiO₂, and/or ZrO₂.

The glass frit(s) may be substantially lead free (e.g., contains less than about 5 wt %, such as less than about 4 wt %, less than about 3 wt %, less than about 2 wt %, less than about 1 wt %, less than about 0.5 wt %, less than about 0.1 wt %, or less than about 0.05 wt % or less than about 0.01 wt %) of lead. In a preferred embodiment, the glass frit is lead-free, i.e., without any intentionally added lead or lead compound and having no more than trace amounts of lead.

The glass frits described herein can be made by any process known in the art, including, but not limited to, mixing appropriate amounts of powders of the individual ingredients, heating the powder mixture in air or in an oxygen-containing atmosphere to form a melt, quenching the melt, grinding and ball milling the quenched material and screening the milled material to provide a powder with the desired particle size. For example, glass frit components, in powder form, may be mixed together in a V-comb blender. The mixture is heated to around 800-1300° C. (depending on the materials) for about 30-60 minutes. The glass is then quenched, taking on a sand-like consistency. This coarse glass powder is then milled, such as in a ball mill or jet mill, until a fine powder results. Typically, the glass frit powder is milled to an average particle size of from about 0.01 to about 10 μm, such as from about 0.1 to about 5 μm.

The paste comprises at least about 1 wt % of total glass frit(s), preferably at least about 2 wt %, and preferably at least about 3 wt %, based upon the total weight of the paste. At the same time, the paste comprises no more than about 15 wt %, preferably no more than about 10 wt %, and most preferably no more than about 8 wt %, of total glass frit(s). In one embodiment, the paste contains at least about 5 wt % of total glass frit, and preferably at least about 7 wt %, based upon 100% total weight of the paste.

### Organic Vehicle

The pastes further comprise an organic vehicle. Preferred organic vehicles in the context of the invention are solutions, emulsions or dispersions based on one or more solvents, preferably organic solvent(s), which ensure that the components of the paste are present in a dissolved, emulsified or dispersed form. Preferred organic vehicles are those which provide optimal stability of the components of the paste and endow the paste with a viscosity allowing for effective printability.

In one embodiment, the organic vehicle comprises an organic solvent and optionally one or more of a binder (e.g., a polymer), a surfactant and a thixotropic agent. For example, in one embodiment, the organic vehicle comprises one or more binders in an organic solvent.

Preferred binders in the context of the invention are those which contribute to the formation of a paste with favorable stability, printability, viscosity and sintering properties. All binders which are known in the art, and which are considered to be suitable in the context of this invention, may be employed as the binder in the organic vehicle. Preferred binders (which often fall within the category termed “resins”) are polymeric binders, monomeric binders, and binders which are a combination of polymers and monomers. Polymeric binders can also be copolymers wherein at least two different monomeric units are contained in a single molecule. Preferred polymeric binders are those which carry functional groups in the polymer main chain, those which carry functional groups off of the main chain and those which carry functional groups both within the main chain and off of the main chain. Preferred polymers carrying functional groups in the main chain are for example polyesters, substituted polyesters, polycarbonates, substituted polycarbonates, polymers which carry cyclic groups in the main chain, poly-sugars, substituted poly-sugars, polyurethanes, substituted polyurethanes, polyamides, substituted polyamides, phenolic resins, substituted phenolic resins, copolymers of the monomers of one or more of the preceding polymers, optionally with other co-monomers, or a combination of at least two thereof. According to one embodiment, the binder may be polyvinyl butyral or polyethylene. Preferred polymers which carry cyclic groups in the main chain are for example polyvinylbutylate (PVB) and its derivatives and poly-terpineol and its derivatives or mixtures thereof. Preferred poly-sugars are for example cellulose and alkyl derivatives thereof, preferably methyl cellulose, ethyl cellulose, hydroxyethyl cellulose, propyl cellulose, hydroxypropyl cellulose, butyl cellulose and their derivatives and mixtures of at least two thereof. Other preferred polymers are cellulose ester resins, e.g., cellulose acetate propionate, cellulose acetate buyrate, and any combinations thereof. Preferred polymers which carry functional groups off of the main polymer chain are those which carry amide groups, those which carry acid and/or ester groups, often called acrylic resins, or polymers which carry a combination of aforementioned functional groups, or a combination thereof. Preferred polymers which carry amide groups off of the main chain are for example polyvinyl pyrrolidone (PVP) and its derivatives. Preferred polymers which carry acid and/or ester groups off of the main chain are for example polyacrylic acid and its derivatives, polymethacrylate (PMA) and its derivatives or polymethylmethacrylate (PMMA) and its derivatives, or a mixture thereof. Preferred monomeric binders are ethylene glycol based monomers, terpineol resins or rosin derivatives, or a mixture thereof. Preferred monomeric binders based on ethylene glycol are those with ether groups, ester groups or those with an ether group and an ester group, preferred ether groups being methyl, ethyl, propyl, butyl, pentyl, hexyl, and higher alkyl ethers, the preferred ester group being acetate and its alkyl derivatives, preferably ethylene glycol monobutylether monoacetate or a mixture thereof.

Acrylic-based resins, and their derivatives and mixtures thereof with other binders, are preferred binders in the context of the invention. Suitable acrylic resins include, but are not limited to, isobutyl methacrylate, n-butyl methacrylate, and combinations thereof. Acrylic resins having a high molecular weight, about 130,000-150,000, are suitable. The binder may be present in an amount of at least about 0.5 wt %, preferably at least about 1 wt %, more preferably at least about 2 wt %, and most preferably at least about 3 wt %, based upon 100% total weight of the paste. At the same time, the binder is preferably present in an amount of no more than about 10 wt %, preferably no more than about 8 wt %, and most preferably no more than about 6 wt %, based upon 100% total weight of the paste. In a most preferred embodiment, the paste includes about 3-5 wt % of binder.

Preferred solvents are components which are removed from the paste to a significant extent during firing. Preferably, they are present after firing with an absolute weight reduced by at least about 80% compared to before firing, preferably reduced by at least about 95%, and most preferably reduced by at least about 99.9%, compared to before firing. Preferred solvents are those which contribute to favorable viscosity, printability, paste stability and sintering characteristics. All solvents which are known in the art, and which are considered to be suitable in the context of this invention, may be employed as the solvent in the organic vehicle. Preferred solvents are those which exist as a liquid under standard ambient temperature and pressure (SATP) (298.15 K, 25° C., 77° F.), 100 kPa (14.504 psi, 0.986 atm), preferably those with a boiling point above about 90° C. and a melting point above about −20° C. Preferred solvents are polar or non-polar, protic or aprotic, aromatic or non-aromatic. Preferred solvents are mono-alcohols, di-alcohols, poly-alcohols, mono-esters, di-esters, poly-esters, mono-ethers, di-ethers, poly-ethers, solvents which comprise at least one or more of these categories of functional group, optionally comprising other categories of functional group, preferably cyclic groups, aromatic groups, unsaturated bonds, alcohol groups with one or more O atoms replaced by heteroatoms, ether groups with one or more O atoms replaced by heteroatoms, esters groups with one or more O atoms replaced by heteroatoms, and mixtures of two or more of the aforementioned solvents. Preferred esters in this context are dialkyl esters of adipic acid, preferred alkyl constituents being methyl, ethyl, propyl, butyl, pentyl, hexyl and higher alkyl groups or combinations of two different such alkyl groups, preferably dimethyladipate, and mixtures of two or more adipate esters. Preferred ethers in this context are diethers, preferably dialkyl ethers of ethylene glycol, preferred alkyl constituents being methyl, ethyl, propyl, butyl, pentyl, hexyl and higher alkyl groups or combinations of two different such alkyl groups, and mixtures of two diethers. Preferred alcohols in this context are primary, secondary and tertiary alcohols, preferably tertiary alcohols, terpineol and its derivatives being preferred, or a mixture of two or more alcohols. Preferred solvents which combine more than one different functional groups are ester alcohols such as 2,2,4-trimethyl-1,3-pentanediol monoisobutyrate (known as texanol), and its derivatives, 2-(2-ethoxyethoxy)ethanol (known as carbitol), its alkyl derivatives, preferably methyl, ethyl, propyl, butyl, pentyl, and hexyl carbitol, preferably hexyl carbitol or butyl carbitol, and acetate derivatives thereof, preferably butyl carbitol acetate, or mixtures of at least two of the aforementioned.

In a preferred embodiment, the organic solvent component includes at least texanol, terpineol, or combinations thereof. The organic solvent may be present in an amount of at least about 50 wt %, and more preferably at least about 60 wt %, and no more than about 95 wt %, more preferably no more than about 90 wt %, and most preferably no more than about 80 wt %, based upon 100% total weight of the organic vehicle. In a preferred embodiment, the organic solvent is present in an amount of about 60-70 wt %, based upon 100% total weight of the organic vehicle.

In a preferred embodiment, the organic vehicle comprises a binder and solvent that have low burnout temperatures (approximately 350° C. or lower) in a nitrogen/low oxygen content environment (such as 10 ppm oxygen), in order to reduce the presence of char residue. Organic vehicles comprising an acrylic resin as the binder and a texanol solvent have been shown to possess optimal clean burning during firing of the paste. In a preferred embodiment, the binder is a mixture of isobutyl methacrylate and n-butyl methacrylate. The ratio of isobutyl methacrylate to n-butyl methacrylate may range from about 25:75 to 75:25, such as about 1:1.

The organic vehicle may also comprise one or more surfactants and/or additives. Preferred surfactants are those which contribute to the formation of a paste with favorable stability, printability, viscosity and sintering properties. All surfactants which are known in the art, and which are considered to be suitable in the context of this invention, may be employed as the surfactant in the organic vehicle. Preferred surfactants are those based on linear chains, branched chains, aromatic chains, fluorinated chains, siloxane chains, polyether chains and combinations thereof. Preferred surfactants include, but are not limited to, single chained, double chained or poly chained polymers. Preferred surfactants may have non-ionic, anionic, cationic, amphiphilic, or zwitterionic heads. Preferred surfactants may be polymeric and monomeric or a mixture thereof. Preferred surfactants may have pigment affinic groups, preferably hydroxyfunctional carboxylic acid esters with pigment affinic groups (e.g., DISPERBYK®-108, manufactured by BYK USA, Inc.), polycarboxylic acid salt of polyamine amides (e.g., ANTI-TERRA® 204, manufactured by BYK USA, Inc.), acrylate copolymers with pigment affinic groups (e.g., DISPERBYK®-116, manufactured by BYK USA, Inc.), modified polyethers with pigment affinic groups (e.g., TEGO® DISPERS 655, manufactured by Evonik Tego Chemie GmbH), fatty alkyl amine (e.g., Duomeen® TDO, manufactured by AkzoNobel N.V.), or other surfactants with groups of high pigment affinity (e.g., TEGO® DISPERS 662 C, manufactured by Evonik Tego Chemie GmbH). Other preferred polymers not in the above list include, but are not limited to, polyethylene oxide, polyethylene glycol and its derivatives, and alkyl carboxylic acids and their derivatives or salts, or mixtures thereof. The preferred polyethylene glycol derivative is poly(ethyleneglycol)acetic acid. Preferred alkyl carboxylic acids are those with fully saturated and those with singly or poly unsaturated alkyl chains or mixtures thereof. Preferred carboxylic acids with saturated alkyl chains are those with alkyl chains lengths in a range from about 8 to about 20 carbon atoms, preferably C₉H₁₉COOH (capric acid), C₁₁H₂₃COOH (Lauric acid), C₁₃H₂₇COOH (myristic acid) C₁₅H₃₁COOH (palmitic acid), C₁₇H₃₅COOH (stearic acid), or salts or mixtures thereof. Preferred carboxylic acids with unsaturated alkyl chains are C₁₈H₃₄O₂ (oleic acid) and C₁₈H₃₂O₂ (linoleic acid). A preferred monomeric surfactant is benzotriazole and its derivatives. If present, the surfactant may be at least about 0.01 wt %, based upon 100% total weight of the organic vehicle. At the same time, the surfactant is preferably no more than about 10 wt %, preferably no more than about 8 wt %, more preferably no more than about 6 wt %, more preferably no more than about 4 wt %, and most preferably no more than about 2 wt %, based upon 100% total weight of the organic vehicle.

Preferred additives in the organic vehicle are those materials which are distinct from the aforementioned components and which contribute to favorable properties of the paste, such as advantageous viscosity, printability, stability and sintering characteristics. Additives known in the art, and which are considered to be suitable in the context of the invention, may be used. Preferred additives include, but are not limited to, thixotropic agents, viscosity regulators, stabilizing agents, inorganic additives, thickeners, emulsifiers, dispersants and pH regulators. Preferred thixotropic agents include, but are not limited to, carboxylic acid derivatives, preferably fatty acid derivatives or combinations thereof. Preferred fatty acid derivatives include, but are not limited to, C₉H₁₉COOH (capric acid), C₁₁H₂₃COOH (Lauric acid), C₁₃H₂₇COOH (myristic acid) C₁₅H₃₁COOH (palmitic acid), C₁₇H₃₅COOH (stearic acid) C₁₈H₃₄O₂ (oleic acid), C₁₈H₃₂O₂ (linoleic acid) and combinations thereof. A preferred combination comprising fatty acids in this context is castor oil.

### Additive(s)

In one embodiment, one or more additives that promote and increase adhesion to the underlying substrate may be included in the paste (hereinafter, the “adhesion promoting additive”). In a preferred embodiment, at least one adhesion promoting additive is used. For example, the adhesion promoting additive(s) may be selected from cuprous oxide, titanium oxide, zirconium oxide, titanium carbide, zirconium resinate (e.g., Zr carboxylate), amorphous boron, aluminum silicate, lithium carbonate, lithium phosphate, lithium tungstate, bismuth oxide, aluminum oxide, cerium oxide, zinc oxide, magnesium oxide, silicon dioxide, ruthenium oxide, tellurium oxide, and combinations thereof.

Where the paste is formulated for use with a Si₃N₄ substrate, the adhesion promoting additive preferably includes aluminum oxide (e.g., Al₂O₃), cerium oxide (e.g., CeO₂), or combinations thereof. In addition to, or in place of aluminum oxide and/or cerium oxide, the adhesion promoting additive may include copper oxide (Cu₂O). In this embodiment, the adhesion promoting additive(s) component may be free from bismuth oxide (Bi₂O₃). In particular, Bi₂O₃ is shown to sublimate at temperatures of 800° C. or higher in a nitrogen atmosphere. Because of this, undesirable staining of the furnace often occurs during firing of the paste on the substrate. As such, in a preferred embodiment, the adhesion promoting additive(s) component contains less than about 1 wt % of Bi₂O₃, preferably less than about 0.5 wt %, and most preferably less than about 0.1 wt %, based upon 100% total weight of the paste. In a preferred embodiment, the adhesion promoting additive(s) includes no Bi₂O₃, aside from incidental impurities. It should be noted that, in this embodiment, the adhesion promoting additive preferably contains no Bi₂O₃, but the glass component of the paste could still include some Bi₂O₃. In an alternative embodiment, the adhesion promoting additive(s) may include Bi₂O₃.

In embodiments where the paste is formulated for use with an AlN substrate, the adhesion promoting additive preferably includes bismuth oxide (e.g., Bi₂O₃), zinc oxide (e.g., ZnO), or combinations thereof, although cerium oxide (e.g., CeO₂) and titanium oxide (e.g., TiO₂) may also be used.

In any embodiment, the paste preferably comprises at least about 0.1 wt %, preferably at least about 0.5 wt %, of an adhesion promoting additive, based upon 100% total weight of the paste. At the same time, the paste preferably comprises no more than about 5 wt %, and preferably no more than about 4 wt %, of the adhesion promoting additive. In one preferred embodiment, the paste comprises about 0.5-2 wt %, preferably about 0.5-1 wt %, of adhesion promoting additive(s). In another preferred embodiment, the paste comprises about 0.5-5 wt % of an adhesion promoting additive.

The paste may also include other additive(s) which contribute to the electrical performance of the paste and electrodes formed thereof. Preferred additives include, but are not limited to, additional solvents, thixotropic agents, viscosity regulators, emulsifiers, stabilizing agents or pH regulators, inorganic additives, thickeners and dispersants, or a combination of at least two thereof. In one embodiment, the paste may include a solvent additive apart from the solvent already present in the organic vehicle. The solvent additive may be included to achieve the desired viscosity for a particular application. In one embodiment, the paste may include no more than about 5 wt % of a solvent, such as texanol, added directly to the paste separate from the organic vehicle. Preferably, the paste includes no more than about 4 wt %, and preferably no more than about 3 wt %, of the solvent additive, based upon 100% total weight of the paste.

### Formation of the Electroconductive Paste

The electroconductive paste compositions described herein may be prepared by any method for preparing a paste composition known in the art. The method of preparation is not critical, as long as it results in a homogeneously dispersed paste. As an example, without limitation, the paste components may be mixed, such as with a mixer, then passed through a three roll mill to make a dispersed uniform paste. The paste can then be deposited, e.g., screen printed, onto a substrate to form electrically conductive leads.

### Forming Conductors

The electroconductive paste compositions described herein may be deposited and fired in a nitrogen atmosphere on either an aluminum nitride (AlN) or silicon nitride (Si₃N₄) substrate to form conductors, such as copper conductors.

In one embodiment, the electroconductive paste compositions may be applied as a base layer composition and a top layer composition. The base layer composition is typically applied directly onto the substrate, and provides optimal adhesion to the substrate. The top layer composition is typically applied over a fired base layer composition or another fired top layer composition. Multiple layers of the top layer composition may be applied in order to build the copper conductor to a desired thickness on the substrate.

Typically, the base layer electroconductive paste composition comprises a higher amount of glass frit than the top layer electroconductive paste composition. In a preferred embodiment, the base layer electroconductive paste comprises from about 1 to about 5 wt % of glass frit. In another preferred embodiment, the top layer electroconductive paste comprises from about 0.5 to about 1.5 wt % of glass frit, based upon 100% total weight of the paste.

The base layer electroconductive paste composition may comprise a higher amount of adhesion promoting additive than the top layer electroconductive paste composition. In a preferred embodiment, the base layer electroconductive paste comprises from about 1 to about 5 wt % of adhesion promoting additive, preferably from about 2 to about 4 wt %, more preferably about 3 wt % of adhesion promoting additive, based upon 100% total weight of the paste. In a preferred embodiment, the top layer electroconductive paste comprises from about 0.25 to about 1.25 wt % of adhesion promoting additive, preferably from about 0.75 to about 1.25 wt %, more preferably about 1 wt % of adhesion promoting additive.

FIG. 1 illustrates a cross sectional/side view of the pastes, both base layer and top layer, deposited on an exemplary substrate 210. A base layer 220 paste is first deposited on the substrate 210 and fired. A subsequent layer 230 formed from a top layer paste is deposited on the fired base layer 220 or previously fired top layer 230 to build up the copper conductor to a desired thickness. In an optional embodiment, a nickel-gold plated layer 240 may be included. The soldered layer 250 functions as the uppermost layer of the substrate.

The pastes may be applied to the substrate via screen printing, stenciling, direct deposition, or any other means known in the art. The preferred application method is screen printing. Typically, a stainless steel mesh screen with an emulsion layer comprising the predetermined circuitry is employed for the screen printing process, for example, 105-200 stainless steel mesh with 0.5 to 0.6 mil emulsion layer thickness.

The printed pastes are typically dried at a moderate temperature to prevent the oxidation of the copper particles. Typically, the drying temperature is about 125° C., and the drying time is about 5-10 minutes. The firing of the substrates (with the pastes applied thereon) are conducted in a furnace at about 850° C.-1,000° C. peak temperature in a low oxygen atmosphere, such as a N₂ atmosphere, typically below 10-20 ppm O₂, preferably about 1-3 ppm O₂. The dwelling time at peak firing temperature is about 5-10 minutes, preferably 8-10 minutes. In one embodiment, the firing of the substrates is preferably between 850-925° C.

Where only one layer of electroconductive is to be applied to the substrate, a copper conductor may be prepared by a process which includes the following steps: (i) depositing an electroconductive paste on a substrate; (ii) drying the substrate with the deposited electroconductive paste at a temperature of about 100-125° C. for about 5-10 minutes; and (iii) subjecting the deposited electroconductive paste and the substrate to a temperature of about 850-1,000° C. in a nitrogen atmosphere comprising about 1-20 ppm oxygen.

Where more than one layer is to be applied to the substrate, a copper conductor may be prepared by a process which includes the following steps: (i) depositing a first layer of base layer electroconductive paste on a substrate; (ii) drying the substrate with the deposited base layer electroconductive paste at a temperature of about 100-125° C. for about 5-10 minutes; (iii) subjecting the deposited base layer electroconductive paste and the substrate to a temperature of about 850-1,000° C. in a nitrogen atmosphere comprising about 1-20 ppm oxygen; (iv) depositing a second layer of a top layer electroconductive paste on the substrate; (v) drying the substrate with the deposited top layer electroconductive paste at a temperature of about 100-125° C. for about 5-10 minutes; and (vi) subjecting the deposited layers and the substrate to a temperature of about 850-1,000° C. in a nitrogen atmosphere comprising about 1-20 ppm oxygen.

The copper conductor may be built to desired thickness by repeating the steps (iv)-(vi). The fired thickness of the copper conductor may be about 25-50 μm for each layer of copper paste. For example, steps (iv)-(vi) may be repeated 1-10 times. A copper conductor of a fired thickness of about 300 μm can be achieved with one layer of base layer paste and seven layers of top layer paste.

According to one embodiment, the assembly is fired in an inert (e.g., nitrogen) atmosphere according to a specific profile. If a copper electroconductive paste is fired in an environment too rich in oxygen, the copper component may begin to oxidize. However, a minimum level of oxygen is required to facilitate burnout of the organic binder in the paste. Therefore, the level of oxygen must be optimized. According to a preferred embodiment of the invention, approximately 1-20 ppm of oxygen is present in the furnace atmosphere. More preferably, approximately 1-10 ppm of oxygen is present in the furnace atmosphere, and most preferably, approximately 1-3 ppm of oxygen is present.

The steps set forth above may be performed on either an AlN or a Si₃N₄ substrate.

The invention will now be described in conjunction with the following, non-limiting examples.

### Example 1

Nine exemplary paste compositions were prepared according to the formulations set forth in Table 1 below. All amounts are provided in weight percent, based upon 100% total weight of the paste. The pastes generally included: (i) copper particles, (ii) a glass frit which included Bi₂O₃—B₂O₃—SiO₂ as the primary oxide components, as well additional oxide components (Li₂O, Na₂O, Nb₂O₅, ZnO) in minimal amounts, (iii) an organic vehicle which included as base components n-butyl methacrylate and iso-butyl methacrylate (binders) in texanol (solvent), and (iv) an adhesion promoting additive. The oxides (Al₂O₃ through ZnO) set forth in Table 1 were the adhesion promoting additives.

TABLE 1
Exemplary Electroconductive Paste Compositions P1-P9

| | P1 | P2 | P3 | P4 | P5 | P6 | P7 | P8 | P9 |
|---|---|---|---|---|---|---|---|---|---|
| Copper particles, | 77.5 | 77.5 | 77.5 | 77.5 | 77.5 | 77.5 | 77.5 | 77.5 | 77.5 |
| Spherical, d₅₀ = 5 μm | | | | | | | | | |
| Copper particles, | 4 | 4 | 4 | 4 | 4 | 4 | 4 | 4 | 4 |
| Angular, d₅₀ = 2 μm | | | | | | | | | |
| Glass frit | 5 | 5 | 5 | 5 | 5 | 5 | 5 | 5 | 5 |
| Organic vehicle | 11.5 | 11.5 | 11.5 | 11.5 | 11.5 | 11.5 | 11.5 | 11.5 | 11.5 |
| Added solvent, | 1 | 1 | 1 | 1 | 1 | 1 | 1 | 1 | 1 |
| texanol | | | | | | | | | |
| Al₂O₃ | 1 | — | — | — | — | — | — | — | — |
| Al₂SiO₅ | — | 1 | — | — | — | — | — | — | — |
| Bi₂O₃ | — | — | 1 | — | — | — | — | — | — |
| CeO₂ | — | — | — | 1 | — | — | — | — | — |
| Cu₂O | — | — | — | — | 1 | — | — | — | — |
| MgO | — | — | — | — | — | 1 | — | — | — |
| MnO₂ | — | — | — | — | — | — | 1 | — | — |
| TiO₂ | — | — | — | — | — | — | — | 1 | — |
| ZnO | — | — | — | — | — | — | — | — | 1 |

The pastes were mixed to a uniform consistency and then printed onto a Si₃N₄ substrate (commercially available from Maruwa Co., Ltd. of Owariasahi, Aichi, Japan) in a one layer formation. The pastes were screen printed using a 105-200 mesh stainless steel screen. The pastes were dried at 125° C. for about 10 minutes and then fired at 890° C. for about 8-10 minutes in a nitrogen atmosphere to form the resulting electrodes.

Each of the exemplary Si₃N₄ substrates was then subjected to a wire peel test to determine adhesion. In this test, leads were positioned over 80×80 mil electrodes which were deposited on the substrate. The substrates were immersed in an Alpha 615 RMA (Rosin Mildly Activated) flux to clean the surface before soldering, then soldered with a lead-free solder (SAC 305) at 240-250° C. for 5 seconds. The test substrates were then cleaned with acetone and allowed to air dry. Lead pull testing was used to determine the force needed to pull the individual leads from the printed electrodes after soldering. The wires were bent to a 90° angle using a mechanical fixture to minimize any variation in bend angle. Each lead was then clamped into the grip of a Zwick/Roell Z5.0 Pull Tester. Each lead was pulled perpendicularly to the substrate until it separated from the printed electrode. The arm movement was set at a constant speed of 400 mm/minute. The grip separation was set at 14.09 inches.

The adhesion results, provided in units of pound-force (lbf), are set forth in Table 2 below. As can be seen, Pastes P1 and P4 exhibited the best adhesive performance. Paste P1 contained the Al₂O₃ adhesion promoting oxide, while Paste P4 contained the CeO₂ adhesion promoting oxide. For thick film layers formed on circuit substrates, an adhesion pull force of about 4 lbf and above is considered good.

TABLE 2
Adhesion Performance of Exemplary Pastes P1-P9

| | P1 | P2 | P3 | P4 | P5 | P6 | P7 | P8 | P9 |
|---|---|---|---|---|---|---|---|---|---|
| Adhesion, lbf | 3.9 | 2.7 | 3.1 | 4.1 | 3.1 | 1.2 | 1.1 | 2.7 | 2.7 |

Certain of the pastes were then screen printed onto additional Si₃N₄ substrates according to the parameters set forth above, but fired at temperatures of 850° C. and/or 925° C. for about 8-10 minutes in a nitrogen atmosphere to form the resulting electrodes. A control paste which included the same combination of copper parties, glass frit, organic vehicle, and added solvent was also prepared, but the control paste did not include any adhesion promoting additive.

Each of these exemplary Si₃N₄ substrates was then subjected to a wire peel test to determine adhesion using the same procedure set forth above. The results are set forth in Tables 3 and 4, respectively. As can be seen in Table 3, at a firing temperature of 850° C., the exemplified pastes P3 and P5 exhibited better adhesive performance as compared to the control paste having no adhesion promoting additive. At a firing temperature of 925° C., all of the exemplified pastes P1, P2, P3, P5 and P9 exhibited better adhesion than the control paste.

TABLE 3
Adhesion Performance of Exemplary Pastes
at 850° C. Firing Temperature

| | Control | | | |
|---|---|---|---|---|
| | Paste | P3 | P5 | P9 |
| Adhesion, lbf | 2.6 | 3.7 | 3.0 | 2.0 |

TABLE 4
Adhesion Performance of Exemplary Pastes
at 925° C. Firing Temperature

| | Control | | | | | |
|---|---|---|---|---|---|---|
| | Paste | P1 | P2 | P3 | P5 | P9 |
| Adhesion, lbf | 2.0 | 4.2 | 3.3 | 2.3 | 2.4 | 2.3 |

### Example 2

A second set of exemplary pastes P10-P17 were prepared according to the formulations set forth in Table 5 below. All amounts are provided in weight percent, based upon 100% total weight of the paste. The glass included Bi₂O₃—B₂O₃—SiO₂ as the primary oxide components, but had additional oxide components in minimal amounts as well. The oxides (Bi₂O₃ through ZnO) were added to the pastes as adhesion promoting additives.

TABLE 5
Exemplary Electroconductive Paste Compositions P10-P17

| | P10 | P11 | P12 | P13 | P14 | P15 | P16 | P17 |
|---|---|---|---|---|---|---|---|---|
| Copper particles, | 53 | 53 | 53 | 53 | 52 | 52 | 52 | 52 |
| Spherical, d₅₀ = 3-4.5 μm | | | | | | | | |
| Copper particles, | 22 | 22 | 22 | 22 | 21 | 21 | 21 | 21 |
| Spherical, d₅₀ = 2.75-3.55 μm | | | | | | | | |
| Copper Particles, | 10 | 10 | 10 | 10 | 10 | 10 | 10 | 10 |
| Angular, d₅₀ = 4.5-5.6 μm | | | | | | | | |
| Glass frit | 3 | 3 | 3 | 3 | 3 | 3 | 3 | 3 |
| Organic vehicle | 10 | 10 | 10 | 10 | 10 | 10 | 10 | 10 |
| Added solvent, | 1 | 1 | 1 | 1 | 1 | 1 | 1 | 1 |
| texanol | | | | | | | | |
| Bi₂O₃ | 1 | — | — | — | 3 | — | — | — |
| CeO₂ | — | 1 | — | — | — | 3 | — | — |
| TiO₂ | — | — | 1 | — | — | — | 3 | — |
| ZnO | — | — | — | 1 | — | — | — | 3 |

The pastes were mixed to a uniform consistency and then applied to an AlN substrate (commercially available from Maruwa America Corporation) in a one layer formation. They were printed onto the AlN substrate and dried and fired according to the same parameters set forth above with respect to Example 1, except that they were fired at a temperature of 925° C. Lead pull testing was then conducted according to the parameters set forth in Example 1.

The results of the pull testing are set forth in Table 6 below. As can be seen, Paste P17 (adhesion promoting additive, ZnO) exhibited the best adhesive performance of 6.1 lbf, which is well above acceptable industry standards. Generally, the pastes which contained the higher amount—3 wt %—of adhesion promoting additive exhibited higher adhesion than the paste which contained the lower amount—1 wt %—of adhesion promoting additive.

TABLE 6
Adhesion Performance of Exemplary Pastes P10-P17

| | P10 | P11 | P12 | P13 | P14 | P15 | P16 | P17 |
|---|---|---|---|---|---|---|---|---|
| Adhesion, lbf | 5.5 | 5.2 | 5.2 | 5.3 | 5.8 | 5.6 | 5.7 | 6.1 |

### Example 3

Another set of exemplary pastes were prepared according to the formulations set forth in Table 7 below. These pastes did not contain any adhesion promoting additives(s).

TABLE 7
Exemplary Electroconductive Paste Compositions P18-P25

| | P18 | P19 | P20 | P21 | P22 | P23 | P24 | P25 |
|---|---|---|---|---|---|---|---|---|
| Copper particles, | 77.5 | 77.5 | 77.5 | 77.5 | 77.5 | 77.5 | 77.5 | 77.5 |
| Spherical, d₅₀ = 3-4.5 μm | | | | | | | | |
| Copper particles, | 4 | 4 | 4 | 4 | 4 | 4 | 4 | 4 |
| Spherical, d₅₀ = 2.75-3.55 | | | | | | | | |
| μm | | | | | | | | |
| Glass frit | 5 | 5 | 5 | 5 | 7 | 7 | 7 | 7 |
| Organic vehicle | 11.5 | 11.5 | 11.5 | 11.5 | 9.5 | 9.5 | 9.5 | 9.5 |
| Added solvent, | 2 | 2 | 2 | 2 | 2 | 2 | 2 | 2 |
| texanol | | | | | | | | |
| Firing temperature | 800° C. | 850° C. | 890° C. | 925° C. | 800° C. | 850° C. | 890° C. | 925° C. |

Each of these pastes were prepared and applied to a Si₃N₄ substrate in accordance with the same parameters set forth in Example 1. Lead pull testing was then conducted. The results are set forth in Table 8.

TABLE 8
Adhesion Performance of Exemplary Pastes P18-P24

| | P18 | P19 | P20 | P21 | P22 | P23 | P24 | P25 |
|---|---|---|---|---|---|---|---|---|
| Adhesion, lbf | 1.6 | 2.9 | 2.0 | 2.0 | 3.1 | 4.1 | 4.7 | 2.0 |

As can be seen in Table 8, those pastes that contained a higher amount of glass frit—7 wt % (Pastes P22-P24)—generally exhibited better adhesive performance at firing temperatures of 800° C., 850° C. and 890° C. as compared to pastes that contained a lower amount of glass frit—5 wt % at the same firing temperatures (Pastes P18-P20). The adhesive performance of the high content glass frit paste and low content glass frit paste at a firing temperature of 925° C. (Pastes P21 and P25) exhibited about the same adhesive performance.

These and other advantages of the invention will be apparent to those skilled in the art from the foregoing specification. Accordingly, it will be recognized by those skilled in the art that changes or modifications may be made to the above described embodiments without departing from the broad inventive concepts of the invention. Specific dimensions of any particular embodiment are described for illustration purposes only. It should therefore be understood that this invention is not limited to the particular embodiments described herein, but is intended to include all changes and modifications that are within the scope and spirit of the invention.

1. An electroconductive paste for use in forming an electrode on a silicon nitride substrate, the paste comprising:
about 50-95 wt % of a conductive metallic component comprising at least two types of copper particles each having a different median particle diameter (d₅₀);
about 0.5-10 wt % of a glass frit comprising at least bismuth oxide, silicon oxide, and boron oxide;
about 0.1-5 wt % of at least one adhesion promoting additive comprising aluminum oxide, cerium oxide, or a combination thereof; and
about 5-20 wt % of an organic vehicle,
wherein wt % is based upon 100% total weight of the electroconductive paste composition.

2. The electroconductive paste according to claim 1, wherein the conductive metallic component comprises:
a first type of copper particles having a median particle diameter (d₅₀) of at least about 4 μm and no more than about 7 μm; and
a second type of copper particles having a median particle diameter (d₅₀) of at least about 0.1 μm and no more than about 3 μm.

3. The electroconductive paste according to claim 2, wherein the first type of copper particles are spherical in shape and the second type of copper particles are angular in shape.

4. The electroconductive paste according to claim 2, wherein the conductive metallic component comprises about 60-95 wt % of the first type of copper particles and about 0.5-20 wt % of the second type of copper particles, based upon 100% total weight of the paste.

5. The electroconductive paste according to claim 1, wherein the glass frit comprises about 50-75% Bi₂O₃, about 10-25% SiO₂, about 1-10% ZnO, and about 10 wt % or less of each of B₂O₃, Li₂O, Na₂O, and Nb₂O₅, based upon 100% total weight of the glass frit.

6. The electroconductive paste according to claim 1, wherein the aluminum oxide is Al₂O₃ and the cerium oxide is CeO₂.

7. The electroconductive paste according to claim 1, wherein the electroconductive paste comprises about 0.5-2 wt % of the at least one adhesion promoting additive, based upon 100% total weight of the electroconductive paste composition.

8. The electroconductive paste according to claim 1, wherein the at least one adhesion promoting additive contains no bismuth or compounds thereof.

9. The electroconductive paste according to claim 1, wherein the electroconductive paste has at least about 5 wt % of the glass frit, based upon 100% total weight of the paste.

10. An electroconductive paste for use in forming an electrode on an aluminum nitride substrate, the paste comprising:
about 50-95 wt % of a conductive metallic component comprising at least three types of copper particles each having a different median particle diameter (d₅₀);
about 0.5-10 wt % of a glass frit comprising at least bismuth oxide, silicon oxide, and boron oxide;
about 0.1-5 wt % of at least one adhesion promoting additive comprising bismuth oxide, zinc oxide, or a combination thereof; and
about 5-20 wt % of an organic vehicle,
wherein wt % is based upon 100% total weight of the electroconductive paste composition.

11. The electroconductive paste according to claim 10, wherein the conductive metallic component comprises:
a first type of copper particles having a median particle diameter (d₅₀) of about 3-4.5 μm;
a second type of copper particles having a median particle diameter (d₅₀) of about 2.75-3.55 μm; and
a third type of copper particles having a median particle diameter (d₅₀) of about 4.5-5.6 μm.

12. The electroconductive paste according to claim 11, wherein the first type of copper particles and second type of copper particles are spherical in shape and the third type of copper particles are angular in shape.

13. The electroconductive paste according to claim 11, wherein the conductive metallic component comprises about 50-60 wt % of the first type of copper particles, about 20-30 wt % of the second type of copper particles, and about 5-15 wt % of the third type of copper particles, based upon 100% total weight of the paste.

14. The electroconductive paste according to claim 10, wherein the glass frit comprises about 40-60% Bi₂O₃, about 20-40% SiO₂, and about 10 wt % or less of each of B₂O₃, Na₂O, Li₂O, Al₂O₃, TiO₂, and/or ZrO₂, based upon 100% total weight of the glass frit.

15. The electroconductive paste according to claim 10, wherein the bismuth oxide is Bi₂O₃ and the zinc oxide is ZnO.

16. The electroconductive paste according to claim 10, wherein the at least one adhesion promoting additive further comprises cerium oxide, titanium oxide, or a combination thereof.

17. The electroconductive paste according to claim 10, wherein the electroconductive paste comprises about 0.5-5 wt % of the at least one adhesion promoting additive, based upon 100% total weight of the electroconductive paste composition.

18. An electronic device, comprising:
(a) a silicon nitride substrate; and
(b) at least one electrode formed from the electroconductive paste according to claim 1 on the silicon nitride substrate.

19. An electronic device, comprising:
(a) an aluminum nitride substrate; and
(b) at least one electrode formed from the electroconductive paste according to claim 10 on the aluminum nitride substrate.

20. An electroconductive paste for use in forming an electrode on a silicon nitride substrate, the paste comprising:
about 50-95 wt % of a conductive metallic component comprising at least two types of copper particles each having a different median particle diameter (d₅₀);
at least about 5 wt % of a glass frit comprising at least bismuth oxide, silicon oxide, and boron oxide; and
about 5-20 wt % of an organic vehicle,
wherein wt % is based upon 100% total weight of the electroconductive paste composition.
